(19) United States
(12) Patent Application Publication
(10) Pub. No.: US 2002/0199156 A1
(43) Pub. Date: Dec. 26, 2002

(54) Hardware-adaptable data visualization tool for use in complex data analysis and engineering design

(75) Inventors: Karen L. Chess, Batavia, IL (US); Daniel J. Heath, Carol Stream, IL (US); William F. Michels, Aurora, IL (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: FUEL TECH, INC.

(21) Appl. No.: 10/026,332

(22) Filed: Dec. 21, 2001

Related U.S. Application Data
(60) Provisional application No. 60/293,143, filed on May 23, 2001.

(51) Int. Cl. G06F 17/50

(52) U.S. Cl. 716/1

(57) ABSTRACT

A hardware-adaptable data visualization tool for use in visualizing data from a data source, including: a data source module, for providing a numerical data set representing aspects of data to be interpreted; and a viewer module, responsive to the numerical data, for providing a view of the numerical data set, such as a fully immersive view or a more limited view, helpful to a user in interpreting the numerical data set; wherein the viewer module in turn comprises a set of component modules, and wherein the source module and the viewer component modules are compiled and linked together into one or more executable files depending on factors including the performance capabilities of a predetermined target host or hosts as well as the desired utility of the executable files, the component modules having programming interfaces that are substantially independent of the predetermined target host or hosts.

### CROSS REFERENCE TO RELATED APPLICATION

Reference is made to and priority claimed from U.S. provisional application Ser. No. 60/293,143, filed May 23, 2001, entitled HARDWARE-ADAPTABLE DATA VISUALIZATION TOOL FOR USE IN COMPLEX DATA ANALYSIS AND ENGINEERING DESIGN.

### FIELD OF THE INVENTION

The present invention relates to software applications for use in complex data analysis and engineering design, and more particularly, to adapting the grouping of modules of such an application so as to provide a highly adaptable application with components that can function acceptably on a range of grades of computing equipment, in a local or distributed manner, and can maximize the application's utility on a given hardware configuration.

### BACKGROUND OF THE INVENTION

The application of visualization techniques to data-intensive tasks and analyses is generally useful for the purpose of facilitating data understanding and the completion of data-dependent tasks (such as making a design decision). The term “visualization” here refers to the transformation of numerical data into graphical objects generated by computer software and viewed by the software user. The application of different colors to different objects, object animation, or similar techniques aids the software user in pattern recognition and other mental cues that lead to data understanding.

An example of a data-intensive task is the engineering design of a pollution control system for a combustion process such as a utility boiler. A boiler burns a fuel to produce heat that is then absorbed by a working fluid (such as water) via a heat exchanger. The products of the combustion, which are ideally simply carbon dioxide and water, also invariably contain other products, some undesirable and considered a form of pollution. One particular class of pollution products includes various nitrogen-oxygen compounds (NOₓ). To reduce the emissions of such pollution, boilers are designed to allow adding to the combustion products, before they are exhausted from the boiler, chemicals that react with the polluting by-products to produce either carbon dioxide and water or other, benign end-products. In this regard, see U.S. Pat. No. 3,900,554 to Lyon, U.S. Pat. No. 4,208,386 to Arand et al, U.S. Pat. No. 4,777,024 to Epperly et al, and U.S. Pat. No. 4,780,289 to Epperly et al., all of which are hereby incorporated by reference.

For example, FIG. 1 shows a boiler including a burner having a fuel injector by which fuel is introduced into a burner cell where the fuel reacts with oxygen (i.e. is burned). The temperature in the cell area typically reaches 2200-2600° F. At a temperature in such a range, both the nitrogen and oxygen in the air, which are both in the form of diatomic molecules at room temperature, break down into free radicals and react to form one or another NOₓ compound. Urea (CON₂H₄) in aqueous solution is stable at temperatures somewhat lower than the temperatures in the burner cell, but reacts with NOₓ at the lower temperatures, typically between approximately 1800° F. and 1950° F., to produce inert nitrogen (N2), carbon dioxide, and water, as explained in the above-mentioned patents. Therefore, modern boilers are equipped with injectors, such as one or more nozzles, by which aqueous urea is introduced into the boiler. For the introduction of urea using such a urea injector nozzle to have the effect desired, the nozzle must be properly placed and must be of such a design as to produce urea/water droplets in a particular size range and with a momentum in a particular momentum range, depending on the geometry of the boiler. Other factors such as urea concentration, flow rates, the particular nozzles used, boiler load, and the like, must also be controlled.

To determine where to best place one or more urea nozzles, and to determine which nozzles to use as well as how to control the other factors on which the combustion process depends, trial and error on the physical system might be appropriate except that because of the way a boiler is built, moving one or another nozzle from one place to another requires extensive modifications to a boiler, because usually, the boiler includes not only heat exchangers in the locations shown in FIG. 1, but also in the walls of the boiler nearer the burner cell and in the region where the urea would likely be injected. Indeed, many of the factors are interrelated: changing one requires changing one or more of the others. Therefore, to move a nozzle from one location to another would require substantial modification of the heat exchanger structure in the walls of the boiler, and so the location of any nozzles to be used to inject urea into a boiler is advantageously made in the process of designing the boiler, and not afterward, using trial and error on the physical system.

The prior art therefore teaches either designing one or more urea nozzles into a boiler (i.e. as part of the boiler design) or modifying a boiler to include one or more urea nozzles with the placement of the nozzles determined once and for all—in either case—based on a set of calculations. The calculations required for this example involve the use of computational fluid dynamics modeling software, modeling software that takes as inputs numerical descriptions of the physical system and properties of the fuel and other mass flows in the system, and that then outputs a numerical dataset representing the values of variables (such as temperature, velocity, chemical species concentrations, etc.) in each cell or at each node of the model. The output dataset is large, for example on the order of 1 million data values for a 100×20×40 cell model calculating and storing a modest 12 variables.

Rather than perform calculations randomly on possible nozzle locations and configurations (trial and error on the computer model instead of the physical system), it is known in the art to perform calculations in such a way that the results can be visualized. In such a design methodology, the calculation corresponding to an initial set of parameters is performed and the user is then presented with a graphical representation (or view) of the combustion process occurring in the boiler. From the view presented, the user is able to ascertain whether it would be advantageous to change to a higher/lower concentration of urea, a higher/lower feed pressure, a different urea nozzle location, or a different type of nozzle. The user is then able to make a desired change, recompute the calculations for a new dataset, view the results of the changed set of parameters, and in a small number of iterations reach a workable design decision.

This methodology, the use of visualization to facilitate the understanding of complex data and the completion of a design task, is constrained by the capabilities and features of the visualization software, which in turn is constrained by the sophistication of the computer hardware necessary to run a given application. The most information-rich visualization environments, commonly known as virtual reality (VR) visualization, require at minimum a high performance workstation with advanced graphics capabilities and specialized hardware for stereo projection or immersion of the user in the “VR world.”

Such a hardware configuration is expensive and non-portable, so less computationally intensive visualization software with a reduced feature set exists to run on lower-end hardware. The prior art teaches that visualization software has been developed and optimized for a specific class of hardware. While VR-style visualization software can be reverse-engineered to lower-end hardware, and non-VR visualization software can similarly be retrofitted to high-performance hardware, the design of a single modular software architecture that is quickly adaptable to a wide range of hardware and operating configurations (e.g., local distributed) is novel and needed.

In addition, what is needed is a software system that allows collaboration between users viewing a dataset in a VR-style viewer on a high performance hardware configuration (e.g., in an office environment) and other users viewing the same dataset at the same time in a non-VR viewer on lower end hardware configurations (e.g., a portable system taken into the field). The modules of such a software system would, ideally, be able to be linked (combined into executable files) in different ways, as a way of addressing the varying performance capabilities of different target host computers. The modules would also, ideally, be able to be linked so as to allow the calculation and visualization tasks in the above-described methodology, the use of visualization to facilitate the understanding of complex data and the completion of a design task, to be performed simultaneously.

### SUMMARY OF THE INVENTION

Accordingly, the present invention provides a hardware-adaptable data visualization tool for use in visualizing data from a data source, including: a data source module, responsive to data source input files indicating information about a geometry to be visualized, for providing as a stream of data to be interpreted a numerical data set representing aspects of the data; and a viewer module, for providing the data source input files, responsive to the numerical data set for providing a view of the numerical data set helpful to a user in interpreting the numerical data set; wherein the viewer module in turn comprises a plurality of viewer component modules, and wherein the source module and the viewer component modules are compiled and linked together into one or more executable files depending on factors including at least either the performance capabilities of a predetermined target host or hosts or the desired utility of the executable files, the component modules having programming interfaces that are substantially independent of the predetermined target host or hosts, whereby different visualization tools are able to be provided all from the same data source module and viewer component modules, the different visualization tools being tailored to different performance capabilities of different target hosts.

In a further aspect of the invention, the viewer component modules include: A hardware-adaptable data visualization tool as claimed in claim 1, wherein the viewer component modules comprise: a geometry manager, responsive to geometry information describing the boundaries of a geometry corresponding to a region being viewed and responsive to changes in the geometry information and associated display characteristics (indicating what graphics to display and how to display the graphics, and also indicating the position and direction of view of a user in an immersive view), for providing a representation of the boundaries of the region being viewed, and for providing the data source input files including information about the geometry; an interface module, serving as the means by which a user of the data visualization tool requests views or requests to view objects, responsive to user tool controls and inputs, for providing changes to the geometry and associated display characteristics, for providing display characteristics associated with graphic representations of visualization objects, for providing flight plans indicating information for providing a view of the numerical data set, and also responsive to summary data, and further for providing graphics output of the summary data; an automation/scripting module, for maintaining flight plans or other standardized instructions for viewing the numerical data set, responsive to the flight plans, for providing changes to display characteristics associated with the flight plans; a visualization object client/graphics module, for retrieving, storing, and displaying dynamic visualization objects that represent information in the numerical data set, responsive to changes to display characteristics, responsive to and for providing summary numerical data, and responsive to visualization data, and for providing graphics representations of visualization objects; a visualization object server, for generating graphical objects, responsive then to data for generating graphical objects, for providing the generated graphical objects; an auxiliary calculation module set, for translating the numerical data set after standard formatting into data for visualization, for providing the data for visualization; and a query library module, for converting different data source program data structures into a standard application programming interface and so allowing visualization of data from data source programs that output data in different formats, responsive to the numerical data set, for providing the numerical data set according to standard formatting; wherein the data source module is either a calculatory data source modules, such as a computational fluid dynamics (CFD) module, or one or another non-calculatory data source modules, such as different sources of empirical data.

In a still further aspect of the invention, the data source module is a computational fluid dynamics (CFD) module.

In another still further aspect of the invention, all of the viewer component modules are compiled and linked together into a single executable file and the data source module is compiled into a separate executable file, thereby providing a data visualization tool in which computing equipment most suitable for computation can be used as a host of the data source module, and computing equipment most suitable for providing a view helpful in interpreting the data stream provided by the data source module can be used as a host of the viewer.

In yet another still further aspect of the invention, the data source module is linked together into a single executable file, the query module, the trackpack module, and the visualization object server module are compiled and linked together into a single executable file, and the other component modules of the viewer module are compiled and linked together into a single executable file, thereby a data visualization tool that is distributed across up to three different target hosts, communicating via a network and/or a file system.

In yet even another still further aspect of the invention, the data source module, the tracking module, and the query module are compiled and linked together into one executable file, thereby making possible the use of the tracking module to generate information on spray trajectories or other similar information used as a basis for source term inputs to the data source module during execution, and wherein the remaining modules, however compiled and linked, form the viewer.

In still yet even another still further aspect of the invention, all of the viewer component modules and the data source module are compiled and linked together into a single executable file, thereby providing a viewer with a capability of examining intermediate results of the data source module as it performs a calculation and steering the calculation of the data source module.

In another further aspect of the invention, the visualization tool is used for the analysis and engineering design of a fluid dynamic system, the data for visualization provided by the tracking module is particle trajectory data, and in addition: the data source module is a CFD module, responsive to data on the geometry of the fluid dynamic system, and provides, as a stream of data to be interpreted, a numerical data set representing flow; and the viewer module is responsive to the numerical data set representing flow, and provides the data on the geometry of the fluid dynamic system, and also provides a view of the numerical data set representing flow in an environment, such as a fully immersive environment, that helps a user interpret the numerical data set. In a still further aspect of the invention in this respect, the data source module, the query library module, the tracking module, and the visualization object server are all compiled and linked together into one executable file, and the other modules, the principal viewer modules, are all compiled and linked together into a second executable file, and wherein the viewer is connected to the data source module via a network link, and so is able to examine intermediate results of the data source module as it performs a calculation and steer the calculation as the data source module is performing the calculation.

In yet even another further aspect of the invention, the visualization tool is used for the analysis and engineering design of a fluid dynamic system in which a reacting flow occurs, and in addition: the data source module is a CFD module, responsive to data on the geometry of the fluid dynamic system, and further responsive to data on sources of reacting species being added to the reacting flow, and provides, as a stream of data to be interpreted, a numerical data set representing flow and other characteristics of the reacting flow; and the viewer module is responsive to the numerical data set representing flow and other characteristics of the reacting flow, and provides the data on the geometry of the fluid dynamic system, and also provides a view of the numerical data set representing flow and other characteristics of the reacting flow in an environment, such as a fully immersive environment, that helps a user interpret the numerical data set.

In still yet even another further aspect of the invention, the visualization tool is for use in designing targeted in-furnace injection systems, such as pollution control systems, for controlling a combustion process, the special features for introducing into the combustion process species that react with the combustion products, and in addition: the data source module is a computational fluid dynamics (CFD) module, responsive to data on the geometry of the combustion system including the special features, and further responsive to data on sources of the reacting species being added to the combustion process, and provides, as a stream of data to be interpreted, a numerical data set representing flow and other characteristics of the combustion process; and the viewer module is responsive to the numerical data set representing flow and other characteristics of the combustion process, and provides the data on the geometry of the combustion system including the special features, and also provides a view of the numerical data set representing flow and other characteristics of the combustion process in an environment, such as a fully immersive environment, that helps a user interpret the numerical data set.

In yet still even another further aspect of the invention, the visualization tool includes two different viewer modules, one viewer module being hosted by a first computer, and the other viewer module being hosted by a second computer, and the viewer modules use the same model data.

In yet still another further aspect of the invention, the viewer component modules comprise: a data visualization module, responsive to geometry information describing the boundaries of a geometry corresponding to a region being viewed and responsive to changes in the geometry information and associated display characteristics, for providing a representation of the boundaries of the region being viewed, and for providing the data source input files including information about the geometry, and also for retrieving, storing, and displaying dynamic visualization objects that represent information in the numerical data set and so responsive to changes to display characteristics, also responsive to and for providing summary numerical data, and responsive to visualization data, and for providing graphics representations of visualization objects; an interface system module, an interface module, serving as the means by which a user of the data visualization tool requests views or requests to view objects, responsive to user tool controls and inputs, for providing changes to the geometry and associated display characteristics, for providing display characteristics associated with graphic representations of visualization objects, and also responsive to summary data, and further for providing graphics output of the summary data, also for maintaining flight plans or other standardized instructions for viewing the numerical data set, for providing changes to display characteristics associated with the flight plans; a data interpretation module, for generating graphical objects, responsive to data for generating graphical objects, for providing the generated graphical objects, and also for translating the numerical data set after standard formatting into data for visualization, for providing the data for visualization; and a data translation module, for converting different data source program data structures into a standard application programming interface and so allowing visualization of data from data source programs that output data in different formats, responsive to the numerical data set, for providing the numerical data set according to standard formatting; wherein the data source module is either a calculatory data source modules, such as a computational fluid dynamics (CFD) module, or one or another non-calculatory data source modules, such as different sources of empirical data.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a schematic diagram of one example of a physical system of which all or part could be designed using the present invention, the example being a boiler for which a pollution control system, based on injecting urea into the combustion products, is to be designed;

FIG. 2 is a block diagram/flow diagram of the invention, showing the various modules that in combination are a viewer (data visualization subsystem), but not indicating any particular linking of the modules;

FIGS. 3A-3E are five figures illustrating different ways in which the modules of the invention can be combined (linked together into executable files) so as to adapt the invention to different utility (applications) and for different grades of host computing equipment including a standalone viewer (FIG. 3A), a remote viewer (FIG. 3B), an integrated solver/source term generator for additional calculations driven by an input file rather than by a viewer (FIG. 3C), and an integrated solver/source term generator/viewer in two embodiments (FIG. D and FIG. 3E);

FIG. 4 is an illustration of the use of the invention where two different ways of combining the modules of the invention cooperate so as to provide a user at an office, where higher grade computing equipment is used to host one arrangement of the modules of the invention, with a different view of the same data being viewed by a worker on site (in the field) where lower grade computing equipment is used to host another arrangement of the modules of the invention, the two cooperating combinations serving therefore as two subsystems of the invention in a distributed system embodiment.

FIG. 5 is a block diagram/flow diagram of the invention, showing the viewer module implemented as four modules, called viewer super-component modules (as opposed to the seven viewer component modules of FIG. 2).

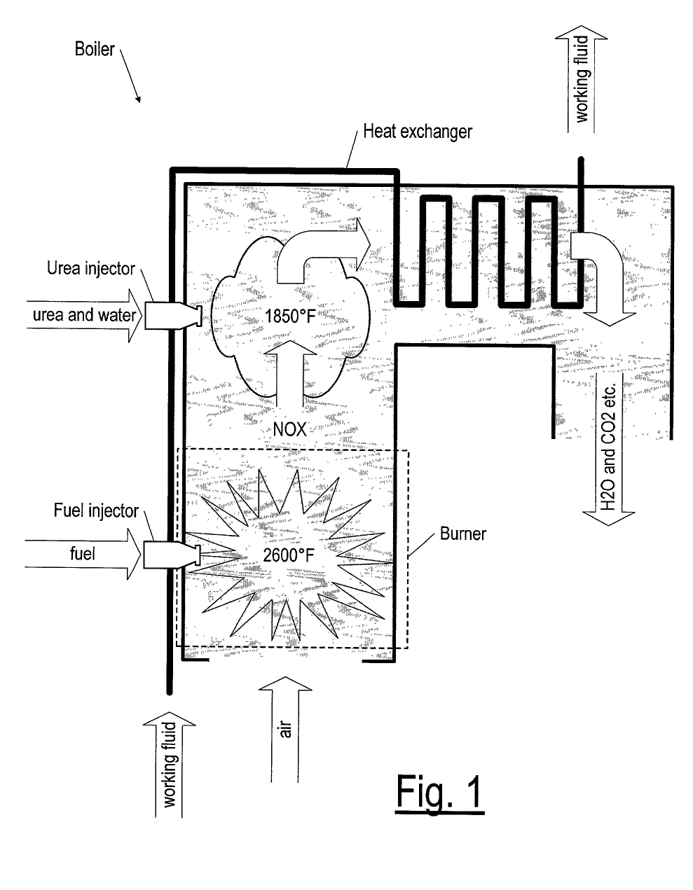

### BEST MODE FOR CARRYING OUT THE INVENTION

To assist a user in interpreting the stream of data provided by model calculations, based on for example CFD or other calculational tools but also based on data sources that are not calculational tools, such as sources of empirical data (e.g. sales data or other business data), and to do so according to a range of computing equipment performance capabilities, the present invention provides a means for developing different data visualization tools from essentially the same set of software modules, the different tools being tailored to different computing equipment.

The invention will be described here in terms of designing urea injectors for a boiler (used to produce steam) to reduce the emission of nitrogen oxide compounds (NOₓ). In particular, the invention will be described in terms of the use of visualization with CFD to model the combustion process within such a boiler, including the effect of injecting urea into the flow of combustion products. As should be clear from what follows, however, nothing about the present invention requires that the data visualization tools provided according to the invention be restricted to modeling a combustion process using CFD, or to designing a urea injection system for a boiler. The present invention comprehends providing tools as described below for use in visualizing complex data from any source and reaching design decisions from said visualization. (A slightly more general application of the invention is an application for designing targeted in-furnace injection systems, which would include pollution control systems for a combustion system.)

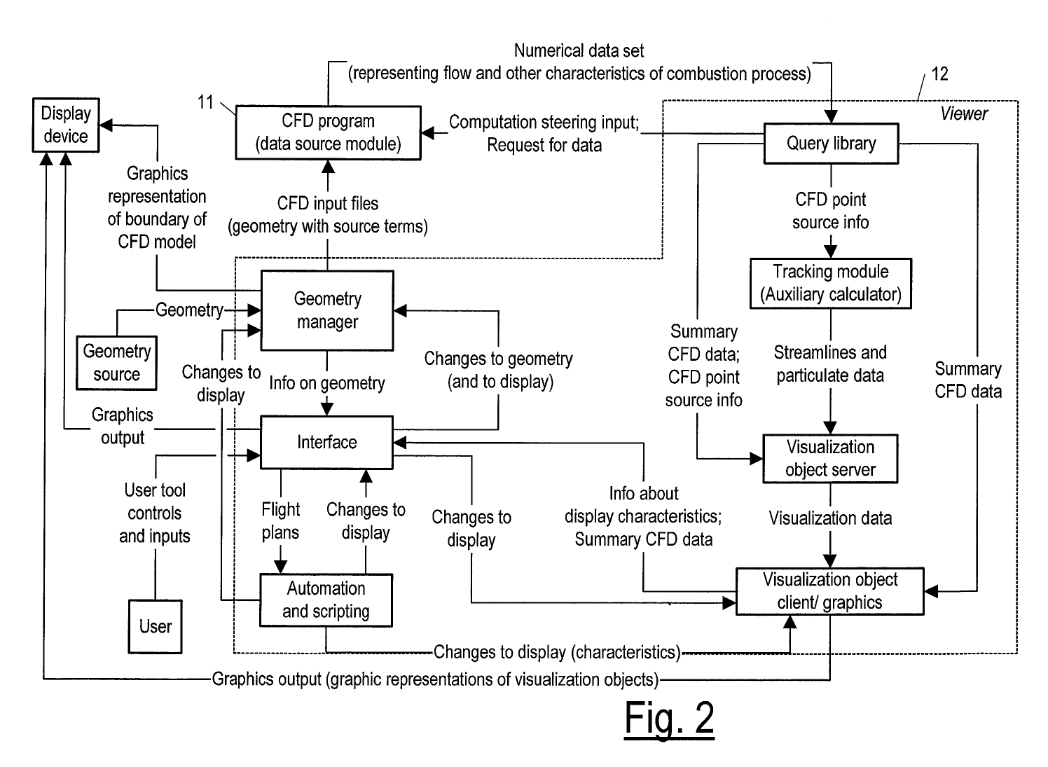

Referring now to FIG. 2, in the preferred embodiment, the invention comprises a set of essentially the same modules linked together in different ways to provide a data visualization tool suitable for a target host. The set of modules includes, in the preferred embodiment, one or another data source module 11 and all of the other modules, which act in combination as a viewer supermodule 12. The data source module 11 produces a data stream that is presented to a user by the viewer 12 to provide a view in a format intended to assist the user in interpreting the data stream, one format being an immersive view, used in case of a high-performance target host; the data source module can be a single module, or can be a set of modules providing different data. The viewer 12 includes one or more modules that are replaced by other modules of similar functionality, depending on the performance capability of the target host. Specifically, the viewer 12 includes a so-called interface module that is implemented differently, depending on the target host. In addition to swapping out modules depending on the target host, as explained below, the modules of the invention, including both the viewer modules and the data source module (such as the CFD module in the embodiment being described), can be linked in different ways, so as to create one or more executable files, as a way of addressing the varying performance capabilities of different target host computers and different desired utility of the system.

A First Viewer: the Desktop Viewer

Referring still to FIG. 2, one embodiment of the viewer 12 is here called a desktop viewer, which is suitable for execution on computing equipment of moderate processing power, i.e. the interface module is implemented so as to provide a viewer suitable for a standard performance personal computer. Graphical objects that cannot be displayed on the (moderate-processing-power) host computer cannot be requested through the desktop viewer interface module.

The desktop viewer uses a standard windows-type interface. The viewing perspective and scale of the, for example, CFD model domain can be changed with a simple mouse movement and button combination. Popup windows brought up by either mouse clicks or menu selections are used to visualize and control contours of model variables on demand. The look of the contour planes can be adjusted to different color scales as well as positions. By sliding contours across the model domain, the characteristics of a specific variable can be quickly screened. Flow trajectories in the desktop viewer can be seen using a streamline tool. The tool uses the visualization object modules to calculate and draw the paths taken by particles that are released in the flow field described by the numerical modeling data. Streamlines can be added, deleted and dragged from one location to another. The tool can also use the visualization object modules (client and server modules) to extract time-temperature data or other values along each streamline for further analysis. The desktop viewer can also be used as an input interface for computational modeling allowing the user to modify geometry definitions and specify block characteristics.

As shown in FIG. 2, the interface module, the visualization object client/graphics module, and the geometry manager module send graphics objects to the display device. The objects from the visualization object client/graphics module are the specific objects related to the data set (streamlines, flow indicators, contour surfaces, etc). The objects from the interface module include dialog and control objects, and so forth. In addition, the graphics output of the interface module includes graphics having to do with summary CFD data. The objects from the geometry manager include special objects representing the geometry (walls, etc.).

A Second Viewer: The VR Viewer

While the desktop viewer can run on a variety of hardware configurations, the need to run with lower-end computer graphics capabilities results in some technical constraints on the view that can be provided. For example, the desktop viewer environment is enlightening, but it is not immersive. By increasing the hardware requirements to those more typical of graphics workstation specifications, a larger amount of animation and a more natural and intuitive interface module can be used. Such a module could also be optimized to run on lower-end hardware by reducing the number of objects animated at the same time. Accordingly, a second embodiment of the viewer 12, what is here called a virtual reality (VR) viewer, uses an intuitive interface module targeted for higher animation performance. The VR viewer uses all of the same modules as the desktop viewer, but the interface module is implemented differently, so as to take advantage of a higher-performance target host, and in particular, to provide a fully immersive view. For example, the visualization object modules used for the VR viewer are the same as those used for the desktop viewer.

With the VR viewer, the user can not only view objects, but can “fly” inside the model domain and interact with the environment. Like the desktop viewer, the VR viewer provides tools for contour plane generation, and in fact uses the same modules to generate those planes. Streamlines can also be added, with the user navigating to any location and demanding instant streamline generation with the click of a mouse. The VR viewer, however, has enhanced animation capability. Velocity vectors, indicating the speed and direction of flow in all or a portion of the domain, can be loaded. These vectors are then released to “fly” (propagate) through the model domain according to the numerical modeling data. As the vectors propagate, the user can reposition the view perspective and in fact view the flow through any perspective, internal or external to the model domain itself. In this way, subtle but decision critical details can be discovered in the modeling results, and a greater understanding of the data is thereby achieved.

As indicated above, in the description provided here, the VR viewer can be used as a data visualization tool in the design of a spray injection application, such as for injecting urea and water into a boiler. Injectors can be added and streamlines indicating droplet path and evaporation are calculated in real time (i.e., typically in less than two seconds). Based on these streamlines, the injectors are then repositioned by the user, and the application continuously recalculates the effect of the spray injection, and updates the immersive view, thereby providing an interactive immersive design environment. Other adjustments to the injectors, such as jet shape, speed and particle size distribution, can be made resulting again in an updated calculation of the streamline essentially instantaneously.

Modular Design

As explained above, the VR viewer and desktop viewer, while providing different views, use many of the same underlying software modules. It is the use of a modular design that allows developing applications that use essentially the same input and perform essentially the same function, but that offer different user interfaces suitable for a range of computing equipment. According to the invention as described below, two or more of the different modules are linked together into different executable files, depending on the target host computing equipment, to provide applications suitable for a range of host capabilities and desired utility.

According to the invention, each module in a software design is responsible for performing distinct tasks that when combined create a complete visualization program or viewer. The visualization program must have a source of the data to be visualized, such as any commercial CFD program module, including, for example, FLUENT, CFX and Phoenics. Any process simulation model or means of data generation may be used. The science may apply to combustion, chemical, physical, financial, or economic processes, or other processes as well. A query library module interprets the data structures from the original data source, such as the CFD module, for use with a standard application programming interface. A tracking module translates the standardized data into particle trajectory data for visualization. The visualization object modules (client and server) retrieve, store and provide for viewing the actual visualization objects, such as streamlines, contours and what are here called flying vectors, i.e. vectors that show the velocity or other data variable and that move along a streamline at a rate proportional to the values of that variable along that streamline, so that for example if the vector represents the velocity of a particular combustion product, and at a given point in the burner the velocity of the combustion product is high, then the velocity vector moving at a higher speed at the given point. To control the visualization of the visualization objects, an automation and scripting module can be used to generate the same objects for datasets of similar form, i.e., the geometry of the model represented by the datasets are similar. (The automation and scripting module actually “plays” a flight plan by sending corresponding display characteristics to the visualization object client/graphics module, the interface module (indicating navigation information), and the geometry manager module (for turning on and off geometry objects), which then each send corresponding graphics output to the display. Also, the automation and scripting module can record a path as it is being flown.) The interface module is responsible for the different views provided by the application, such as the view provided by the desktop viewer and the view provided by the VR viewer. Finally, a geometry manager draws the static model domain itself, such as the wire frame outline or the textures shown on domain walls. The geometry manager can also be used to alter the input files of the data source module if the data source module provides calculated data, i.e. if the data source is a calculatory tool, such as a CFD module, as opposed to a source of empirical data, such as a source of sales data.

(For clarity, only the primary data flows between the viewer component modules are indicated in FIG. 2. Thus, for example, where FIG. 2 indicates that the query library module provides CFD point source data to the tracking module, the provided data flow is in response to a request by the tracking module for the CFD point source data, a request that is not shown in FIG. 2. Also for clarity, some data stores used by the modules are not shown. For example, the automation and scripting module uses a data store for what are here called flight plans, which are data indicating a sequence of views to show to a user; that data store is not indicated in FIG. 2, nor are any other data stores.)

Different viewers, like the desktop viewer and VR viewer, may use a different interface module but the remaining modules of the linked code are left unchanged, because the basic tasks required are the same. For example the users of different viewers use a different interface to request the display of a streamline, but the request can be fed to the exact same visualization object modules to get the streamline object, which in turn requests the streamline data from the exact same tracking module. The tracking module gets the data through the same instance of the query library, which interprets the same data source (such as the CFD module). The final streamline is then passed back up the modules and displayed.

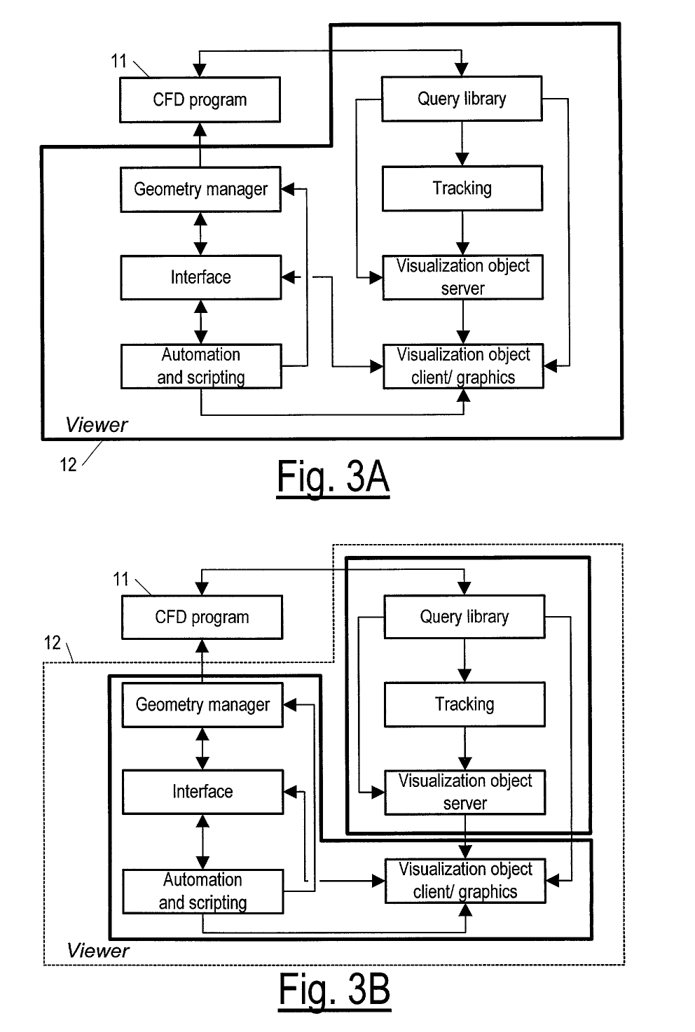

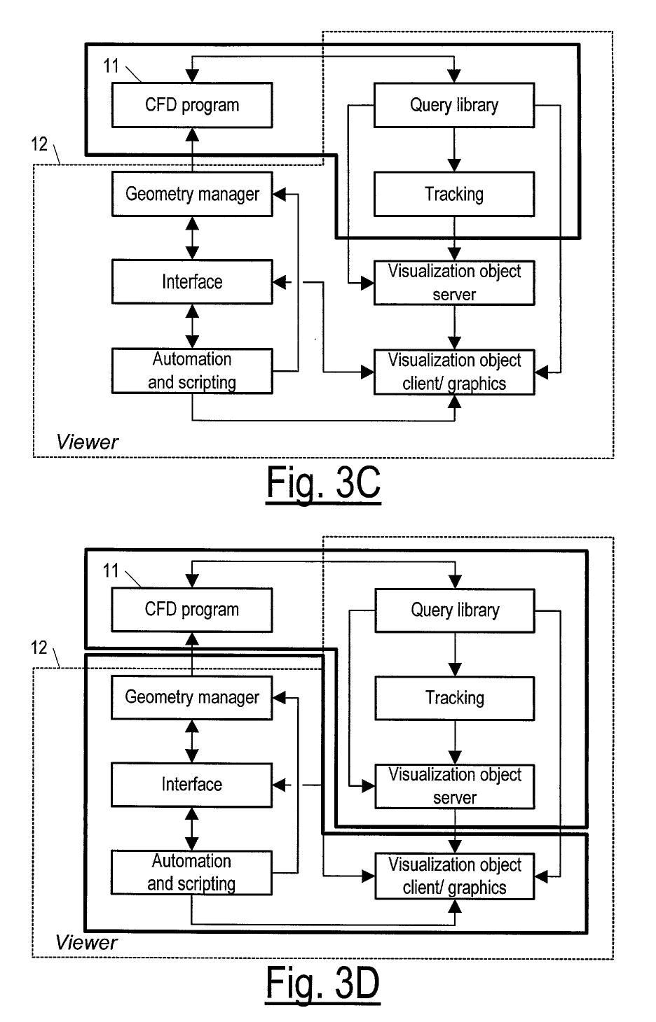

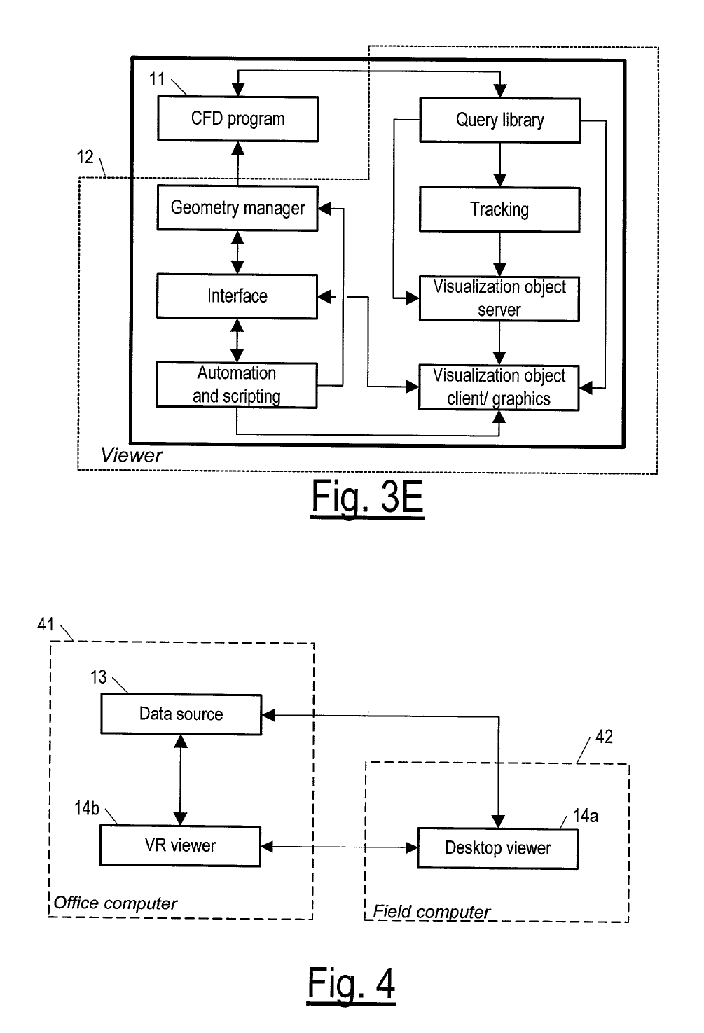

As mentioned above, the modular design approach allows for a variety of viewer configurations. Referring now to FIG. 3A, in one embodiment (configuration) all of the modules of the desktop viewer or VR viewer are compiled into one executable program, and can be used with data residing on the same local machine.

Referring now to FIG. 3B, still another embodiment is to have the query library, tracking, and visualization object server modules compiled and linked together as a first executable, and to compile and link the remaining viewer modules into another, second executable. The first executable accesses the CFD data and performs calculations for visualization, while the second executable receives the results of those calculations and displays the visualization. The two executables are connected by a network link. This configuration is particularly useful for field work and client visits, where the data source remains in a repository and is accessed from the remote location.

Referring now to FIG. 3C, it is also possible to compile and link some of the modules, such as the query library and the tracking modules, together with the CFD program 11 (or other data source program). In the case where the data source program is a CFD program, such an arrangement allows, for example, the coupling of spray calculations generated by the tracking module as source terms into the CFD calculation. (The tracking module in such a case would calculate, for example, the trajectories of sprays and the resulting mass, species, etc. in each location along that trajectory. This information becomes “source terms” for the CFD module to calculate the effect of that spray on the bulk flow, the diffusion of the sprayed chemical within the CFD grid, etc.) The key functionality of the embodiment of FIG. 3C does not require a viewer, but instead uses an input file to control the tracking module for source term information (such as injector locations). (The remaining modules, however compiled, form the basis of the viewer that would be used to visualize the CFD results. The embodiment of FIG. 3C, i.e. the executable file formed by compiling and linking together the CFD module the tracking module and the query library, is a source term generator that uses the same modules as the visualization tool.)

Referring now to FIG. 3D, in yet another embodiment, two executable files are used, one including several of the principal modules of the viewer, and the other including the CFD module. The two modules are then allowed to communicate by for example a network. The result is that the viewer can look at intermediate results of the calculations being performed by the CFD module (or other data source that is a calculatory tool) and actually steer the calculation (make changes to boundary conditions or other aspects of the CFD input files to redirect the results toward a different solution) as the module is performing the calculation.

Referring now to FIG. 3E, in yet another embodiment, all of the modules of the invention are compiled and linked together. The result is an integrated solver/viewer able to steer data calculations and visualize the results simultaneously in a single executable.

Thus, the invention's modular design approach to advanced visualization software provides a solid but flexible foundation from which to develop a wide range of viewer programs. The invention encompasses developing new modules more suitable for specific applications to be incorporated into an application in place of an existing module, and especially new interface modules, to create applications that satisfy different hardware constraints or performance criteria.

The Modules of the Preferred Embodiment

The modules of the preferred embodiment are described here in more detail. As mentioned above, in the preferred embodiment the data source module is a CFD program and the application is the analysis and engineering design of fluid dynamic systems, especially those involving sprays and particle tracking. An example of such an application is the analysis and design of pollution control equipment for a boiler, and the modules of the invention are here described for that particular application. Also, the modules indicated above and shown in FIG. 2 are the modules of the preferred embodiment, regardless of what is used as the data source module. In other embodiments or applications, it is possible that the viewer would not include one or more of the viewer modules indicated in FIG. 2. For example, it is possible that there would not be a geometry manager if the data source module is a non-calculatory tool (a source of empirical data) such as a source of business sales data. It is of course also possible that there would be a geometry manager in such an application, but a geometry manager in a broader sense than in an application for visualizing what occurs in a bounded physical space, i.e. in a “geometry” as the term is used in the preferred embodiment. The inventors have discovered that the seven viewer modules of FIG. 2 can allow visualizing essentially any process in any setting, or any static configuration (such as for example the temperatures, pressures, and constituents of materials at various depths along the track of a bore hole used to extract oil and natural gas from an underground reserve). Moreover, as indicated above, it is not essential that the data source module be a calculatory tool; it could instead be a source of empirical data, such as a module providing actual data on the prices of commodities combined with data that may or may not be correlated to the commodity prices. The invention is, in its essence, the combination of some data source, on the one hand, with various modules serving as a viewer, on the other hand, the viewer modules for use in visualizing data provided by the data source module, wherein the modular design of the viewer (in the sense that any of the viewer modules could be replaced by another module having the same programming interfaces to others of the modules but substantially different functionality) allows various advantages, including realizing any of the embodiments illustrated in FIGS. 3 through 4 discussed above, with their attendant advantages as described above. In addition, even though not expressly indicated in any of the figures but mentioned above, the modular design also allows replacing the interface module in a set of viewer modules with some other interface module (or interface modules in the case of FIG. 4) having the same programming interfaces, so that the visualization provided by any of the configurations indicated in FIGS. 3 through 4 can be tailored to the processing capability of the computer hosting the interface module, providing a more or less fully immersive view depending on the processing capability of the host.

Referring again to FIG. 2, the modules of the preferred embodiment include first a CFD module as the data source module. The purpose of the data source module is to generate or store in some native format (i.e., original to the data source itself) the dataset to be visualized. The CFD module may be any one of a number of commercially available CFD programs, such as: FLUENT, available from Fluent, Inc.; CFX, available from AEA Technology; and Phoenics, available from CHAM. Table 1 shows the input/output connections between the data source module and the other modules of the invention, in the case where the data source module is a CFD program.

TABLE 1
Input/Output connections of the CFD module to the other
modules.

| | |
|---|---|
| Input from geometry | A description of the boundary and source terms |
| manager module | used to compute the CFD solution of a physical |
| | system. |
| Input from the | (Non-geometry) computation steering input, used |
| query library | for steering the computation of the CFD module |
| module | (or for steering the generation of data from a |
| | data source module); and also requests for data, |
| | used to periodically obtain data to be |
| | visualized. Computation steering input would for |
| | example change parameters used in the calculation |
| | “on the fly.” (The geometry manager also |
| | provides some computation steering input: that |
| | relating to the geometry; the input from the |
| | query library is non-geometry computation |
| | steering input.) |
| Output to the query | A numerical data set representing the flow and |
| library module | other properties of the physical system. |

The purpose of the geometry manager is to draw the static model domain itself, i.e. the wire-frame outline or textures shown on the domain walls, in the window seen and manipulated inside the visualization program. (As indicated above, a geometry manager might not be needed in some applications.) The input to this module is a geometry file, indicated in FIG. 2 as the geometry source, describing the position and size of the walls needed to represent the system's geometry, as well as other attributes, and including source terms. The geometry file can be authored “off-line” or can be built from inside the desktop Viewer or other viewer application. The outputs of the geometry manager are graphical objects shown on the screen. As previously mentioned, it is intended that the geometry manager will also be used to generate or alter the input files to the CFD or other data source program, if the data source uses input files to generate its output. The geometry manager also has Input/Output connections with the interface module to allow the geometry to be changed. The input/output connections of the Geometry Manager with the other modules of the invention are shown in table 2 in the instance of a CFD program as the data source.

TABLE 2
Input/output connections of the geometry manager.

| | |
|---|---|
| Output to CFD module | A description of the boundaries of the region to |
| | be modeled, including source terms. |
| Output to display | A graphics representation of the boundary of the |
| device | CFD model and other static graphics used to add |
| | realism/understanding to the CFD model. |
| Input/Output to the | Information about and changes to the current |
| interface module | display data. |
| Input/Output to file | Saves/restores display data. |
| Input from automation | Changes to display characteristics resulting in |
| and scripting module | geometry objects being turned on and off. |

The geometry manager in the more general case provides a description of the space in which the conditions occur giving rise to the data being visualized. For example, in an oil and gas borehole application, where the data source module would be a source of (actual) seismic data and possibly (actual) data obtained from sensors of temperature and pressure as well as a source of predicted or calculated data (usually extrapolated in some way from the empirical data), the geometry manager would describe the depth of the borehole and the region surrounding the borehole for which data (both empirical and calculated) is being provided. In a commodity tracker application, in which the data source module would be a source of actual commodity prices and other actual data hypothesized to be correlated to the commodity prices (or to changes in the commodity prices) and possibly also a source of predicted commodity prices, the geometry manager could for example describe an abstract space having as dimensions the prices of the different commodities being tracked (over time), the values of hypothetically correlated parameters, and perhaps the values of predicted commodity prices, along with a time dimension. Thus, the geometry manager in such a case would not describe a bounded space, but an unbounded abstract space. Of course the interface module could not display more than three dimensions, and so would display slices of the abstract space set out by the geometry manager if the space is more than three dimensions.

The interface module is responsible for the different looks of the visualization tool, such as the desktop viewer or VR viewer, and it is the means by which the user of the visualization software requests views or viewing objects available from the visualization tool. Some of the inputs to the interface module are therefore user commands, such as mouse clicks and keyboard strikes. The outputs from the interface module are requests to the visualization object clients/graphics module, geometry changes to the geometry manager, and requests/changes to the Automation and Scripting module. The calculations and visualization done by the interface module are limited to user interface elements and view position. The interface module depends on and delegates to the other modules of the application any advanced visualization or computation tasks. The input/output connections of the interface module with the other modules are shown in Table 3.

TABLE 3
Input/output connections of the interface module.

| | |
|---|---|
| Input/Output from the user | All I/O to and from the user is controlled |
| | by this module. This allows the user to |
| | control the geometry manager, |
| | visualization object clients/graphics and |
| | Automation and Scripting modules. |
| Output to geometry manager | Changes to geometry data and to display |
| | characteristics (indicating what graphics |
| | to display and how to display the |
| | graphics, and also indicating the position |
| | and direction of view of a user in an |
| | immersive view) for the geometry. |
| | (Display characteristics data are used by |
| | both the geometry manager and the vis |
| | object client/graphics module, discussed |
| | below.) |
| Input from geometry manager | Information on current geometry including |
| | associated display characteristics. |
| Input from visualization | Summary CFD data (max, min, etc.) and |
| object clients/graphics | information on current display |
| | characteristics. |
| Output to visualization | Changes to display characteristics, and |
| object clients/graphics | commands to add/remove CFD |
| | visualization objects. |
| Input from | Information about flight plans and scripts |
| Automation/Scripting | that the user may want to change or use, |
| | and also changes to display |
| | characteristics related to navigating |
| | through a geometry. |
| Output to | Request to use or modify a flight plan or |
| Automation/Scripting | a script. |

The interface module in the more general case is conceptually the same as in the preferred embodiment (with a CFD module as the data source module).

The Automation/Scripting module stores “flight plans” or other standardized instructions for viewing a data set the same way multiple times. The input to this module is a file of instructions describing the desired views, either authored offline or “recorded” or constructed via the interface module. The outputs of the Automation/Scripting module are requests to the visualization object client/graphics module, and potentially also instructions to the interface module. The input/output connections of the Automation/Scripting module with the other modules are shown in table 4.

TABLE 4
Input/output connections of the Automation/Scripting
module.

| | |
|---|---|
| I/O to file | Save information about flight plans, etc. |
| I/O to interface | Changes/Information to/about flight plans, etc. |
| Output to | Changes to display characteristics, add/remove CFD |
| visualization | visualization objects. |
| object client | |
| Output to | Changes to display characteristics resulting in |
| geometry manager | turning geometry objects on and off. |
| Output to | Changes to display characteristics, add/remove CFD |
| visualization | visualization objects. |
| object client | |

The Automation/Scripting module in the more general case is conceptually the same as in the preferred embodiment (with a CFD module as the data source module).

The visualization object client/graphics module retrieves, stores, and displays the actual dynamic visualization objects like streamlines, contours and flying vectors that represent the information in the, for example, CFD data set. (The distinction between this function and the function of the geometry manager is that the geometry manager handles only static objects, e.g., the walls of the model.) The client-side module takes as inputs the requests for visualization objects from the user via either the interface module or the Automation/Scripting module. Some of these operations require new data from the query library module or the visualization object server module. In response to these operations, requests are sent to either or both the visualization object server module or the query library module. As a result the needed data are created or found and provided as input to the visualization object client/graphics module. The input/output connections of the visualization object client/graphics module with the other modules are shown in table 5.

TABLE 5
Input/output connections of the visualization object
client/graphics module.

| | |
|---|---|
| Input from | Changes to display characteristics, |
| Interface/Automation and | add/remove CFD visualization objects. |
| Scripting | |
| Output to Interface | Information about display characteristics |
| | and summary CFD data, such as the minimum, |
| | maximum, and mean. (The summary data are |
| | sent from the query library to visualization |
| | object client and passed through in some |
| | instances to the Interface.) |
| Input from query library | Summary data about CFD model |
| Output to query library | Request to load additional data |
| Output to visualization | Request for specific CFD visualization data |
| object server | or calculations to be performed, i.e. |
| | calculate a streamline and return the data. |
| Input from visualization | CFD visualization data |
| object server | |
| Output to display device | A graphics representation of CFD |
| | visualization objects |

The visualization object client/graphics module in the more general case is conceptually the same as in the preferred embodiment (with a CFD module as the data source module). Whatever objects are being visualized (the actual objects being provided by the visualization object server as described below), the visualization object client/graphics module provides the objects, as requested to the interface module.

As just described, the visualization object client/graphics module communicates with the user interface and/or automation modules to take requests for display objects, and may also communicate directly with the query library for summary data. The visualization object server module, on the other hand, is needed to generate any CFD graphical object. The server module takes as inputs the requests for such objects from the client module. The outputs in these cases are requests to either the tracking module or the query library (depending on the object) for the data to be displayed. The visualization object server may further digest these data. The server module also takes data back from either of these modules as inputs. In any case the output is the actual graphical object to be displayed. The input/output connections of the visualization object server module with the other modules are shown in table 6.

TABLE 6
Input/output connections of the visualization object
server module.

| | |
|---|---|
| Input from | Request for specific CFD Visualization data or |
| visualization object | calculations to be performed, i.e. calculate a |
| client | streamline and return the data. |
| Output to | CFD visualization data |
| visualization object | |
| client | |
| Input from query | Summary CFD data and specific CFD data, such as |
| library | CFD point source information (information at a |
| | particular point location and time). |
| Input from tracking | Streamlines/particulate data |
| module | |

The visualization object server module in the more general case is conceptually the same as in the preferred embodiment (with a CFD module as the data source module), but of course the objects being visualized change with the application and so the objects provided by the visualization object server module vary with the application. If the application does not involve in some sense flow through a geometry, there would not likely be “flying vectors” or other objects specific to a flow process. Instead the objects being visualized would be relevant to the application. For example, in case of an oil and gas exploration application, the objects being visualized could be scalable icons indicating different kinds of materials in different concentrations, as well as icons indicating temperature or pressure.

The purpose of the tracking module is to translate data from the query library into particle trajectory data for visualization. As such, it takes as inputs the requests for data from the visualization object server module, calculates that data, and outputs it to the visualization object modules for conversion to a graphical object to be displayed. In the act of calculation, the tracking module makes many requests to the query library and receives data back from the query library in response to those requests. The steps taken by the tracking module to digest the query library data into data suitable for viewing the requested visualization object are unique to objects requiring “tracking.” For example, a CFD data set describes the speed and direction of fluid within each cell of the grid. To generate a “flying arrow” or other object that starts in a specified location and moves through that grid according to the speed/direction information in each cell, calculations to continually “correct” the path of the object are required throughout the geometry. In technical terms, the function of the tracking module is to take a so-called Eulerian data set and generate so-called Lagrangian trajectories. The input/output connections of the tracking module with the other modules are shown in table 7.

TABLE 7
Input/output connections of the tracking module.

| | |
|---|---|
| Input from query library | CFD point source information |
| Output to query library | Requests for CFD point source |
| | information |
| Input from visualization object | Requests for data |
| server | |
| Output to visualization object | Streamlines/particulate data |
| server | |

In the more general case, the tracking module translates data from the query library into not particle trajectory data, but rather into data describing the trajectory through the geometry of some relevant object, which may be an abstract quantity.

The tracking module should be understood in the more general context as one or another module in a set of auxiliary calculation modules. Examples of such auxiliary calculation modules include a module that performs statistical calculations (such as the distribution of residence times for species in a reaction vessel) or a module that performs pattern recognition algorithms in order for the software to highlight patterns in the data for a user.

The query library module interprets the different CFD (or other data source program) data structures for use with a standard application programming interface. Since not all programs output their data in the same format, the query library allows the visualization module to work with many different data source programs. This is implemented as a set of plug-ins that can be extended as necessary for new data sources. The query library takes as inputs the requests for data from either of the visualization object modules or from the tracking module. The output of the query library is the correct data, standardized to a format understood by all the other modules of the visualization program. That output is sent to whichever module requested the data. The input/output connections of the query library module with the other modules are shown in table 8.

TABLE 8
Input/output connections of the query library module.
Some additional, implied inputs include requests for data from other
modules.

| | |
|---|---|
| Output to tracking module and to | CFD point source information |
| visualization object server | |
| Output to visualization object | Summary CFD data |
| server or client/graphics module | |
| Input from CFD Program | Numerical data set (files |
| | containing the CFD model and/or |
| | live results from a running CFD |
| | application) |

The query library module in the more general case is conceptually the same as in the preferred embodiment (with a CFD module as the data source module); it interprets the data structures provided by the data source module for use with a standard programming interface, adapting to each different data source programs so as to make the viewer modules compatible with each different data source program. This module and the geometry manager are two modules of which it could be said that the programming interfaces vary, but only in their details. The programming interfaces for these two modules are conceptually the same for any application, i.e. for any data source module.

Other Aspects of the Preferred Embodiment

General User Interface

1. Use an Advanced Virtual User Interface to Extend the Usefulness of a CFD VR Application.

An advanced virtual user interface differs from most VR user interfaces in that an advanced user interface is generalized, and extendable, and able to handle more inputs and display more kinds of data without significantly increasing the complexity of the user interface. An advanced virtual user interface gives the user quantitative information as well as the usual qualitative information provided by conventional VR user interfaces. With a conventional VR user interface, one can “fly through” a geometry and view qualitative information. With an advanced virtual user interface, one can view not only qualitative information, but also exact numerical information about data described on contour planes, including information about the location of the contour planes. (In conventional VR applications, one can view a contour, but one is not provided with the location of the contour.) In addition, an advanced virtual user interface is distinguished from conventional VR interfaces in that an advanced virtual user interface provides a layer of abstraction for interacting with the graphical objects being viewed. In a conventional implementation of VR, one is made to feel as if one is “flying through” a geometry, and one is able to position or reposition graphical objects in the geometry by dragging them to the desired position. The layer of abstraction is, for example, provided by dialog boxes linked to each object, allowing the objects to be manipulated. Thus, by incorporating an advanced virtual user interface into the data visualization tool, the tool can be made to provide quantitative information, a large number of intuitive options, and, in addition, a larger feature set of graphics tools.

2. Connected Desktop and VR Applications.

As already indicated, the desktop viewer and the VR viewer (the VR application) are both designed to work on the same set of files. Moreover, tools in both applications work similarly and provide similar functionality. However, the two applications are tuned differently, to take advantage of the different user interfaces they provide. In one aspect of such tuning, the desktop application is based on the assumption that it is acceptable to take a relatively long time to perform a drawing. The desktop application is therefore allowed or tuned to increase the complexity of a view because it has more time to draw the view. Thus, the desktop application is tuned to perform relatively static, complex views of data. The VR application, on the other hand, is assumed to have only a relatively limited time to perform a drawing, so the VR application is tuned to provide relatively more animation and movement (at the cost of increased complexity). So although the same data are provided to both viewers, one is tuned to provide a complex but static view and the other is tuned to animate a less complex representation of the same data.

3. Use Multiple Synchronized Dialog Boxes to Prevent Data Corruption.

In the preferred embodiment, the desktop viewer uses a synchronization mechanism between dialog boxes in the program. This feature is independent of the modular design of the present invention. Such a synchronization mechanism allows two dialog boxes with the same content to be open at the same time without causing data integration problems between the dialog boxes. The same mechanism is used when the specific data are shown in a dialog box and more general data are shown in a separate box. A concrete example is a so-called Block Listing dialog box, which provides the name and color of all blocks, and a so-called Block Configuration dialog box, which provides user adjustable information about a selected one of the blocks. With the synchronization mechanism in place, when the definition of a graphical object, such as a contour plane or a block, is changed, the synchronization mechanism sends out a message to all interface objects (such as dialog boxes) referencing the graphical object, signaling that the object has changed so that the interface objects can update their interface to the object.

4. Use Separate Control Dialog Boxes and Visualization Windows.

The desktop viewer uses separate control dialog boxes and visualization windows, which is beneficial when running on multi-headed machines (machines with more than one monitor) and allows the user greater flexibility in laying out controls (for accessing control dialog boxes) on the screen. It is also possible to control multiple visualization objects in multiple views of the data.

5. Use a Strong Scripting Language to Control Instantaneous Visualization of Data.

It is advantageous, at least in some applications, to use a strong scripting language to drive a real-time visualization session, real-time in the sense of interactive as opposed to batch processing. Often, video output of visualization software is provided according to a scenario of, “set up the shots, ask the computer to render the video encompassing those shots, and come back in an hour or longer to retrieve the usually relatively short video.” In some applications of the invention, the automation/scripting module uses a strong scripting language, so that when a command, “Play flight plan #1 (for “flying” through for example a boiler),” is given, the visualization software does so without any appreciable delay.

6. Use a Script File to Generate a Complex Visualization Picture, and so Allow a Large Rastor Image to be Saved in a Very Small Space.

A reasonable looking printout of an image from a data visualization tool according to the invention is on the order of 10 k by 10 k pixels. This is a very large file. It is sometimes advantageous to generate a script file that can be used to recreate the desired image. Such a script file is significantly smaller than the image. The script file relates to the image file in a way similar to how a Windows metafile relates to the actual output file of an application, or, alternatively, to how a postscript file is related to an image file. The “script file” being referred to here should be distinguished from a “flight plan.” The “script file” contains information corresponding to a “screen dump” of a particular view provided by the viewer, information that is compact expression of the screen dump. A “flight plan,” on the other hand, indicates a series of views to show along a path through a geometry; the views are provided in real-time or for generating movies.

General Software Development

7. Use the Same Graphical Library for Both VR Juggler and CAVElib Based Applications.

CAVElib and VR Juggler are base libraries specifically for use with virtual reality applications. Such libraries provide a generic application programming interface to specific VR hardware. CAVElib is proprietary software from VRCO, Inc., while VR Juggler is open source code (under Lesser GNU Public License) from Iowa State University. In the preferred embodiment, the modules of the invention are implemented using object-oriented programming. Such an implementation provides object structures that can use the same graphics libraries (like the geometry manager and visualization object client/graphics modules) in applications based on different and distinct VR base libraries, including VR Juggler and CAVElib. The viewer graphics library modules of the invention are, in one embodiment, compatible with either one. It is unusual for modules of a viewer to be compatible with more than one VR base library.

Visualization Object Client/Server Advancements

8. Provide Multiple Pulses on a Streamline.

In the preferred embodiment, the viewer places multiple graphical representations of particles on a single streamline, allowing the streamline to visually represent more particles than are calculated.

9. Color Streamlines by Time of Life.

In the preferred embodiment, streamlines are colored by the viewer to indicate additional information, such as the time elapsed since the creation of the streamlines. (In some embodiments, they are colored by local temperature or other variables along the streamline.) Conventional viewers typically color streamlines based on any variable represented by the CFD data, but not based on a calculated field, such as time of life.

10. Use Color Map Plug-Ins.

In the preferred embodiment, the data visualization tool allows a user to code a color map using one or another function f(s) for mapping a scalar value s to a desired color in the so-called RGBA space. An example is a linear function dividing the red, green, blue color scale into sixteen sections representing sixteen equally spaced ranges of the values of a variable, i.e., a linear-16 scale. Other examples are a linear-8 scale, a linear-32 scale, and a log scale. One or another of these scales may be a better scale for a particular dataset or variable, better at least for one or another purpose. Dialog boxes that control constant parameters to the function are also coded and placed in plug-ins.

11. Provide Injectors, Massed Injectors, Streamlines, and Particle Animation Using the Same Streamline Code.

In the preferred embodiment of the invention, the visualization object client/graphics modules use one code section to visualize all of the different types of tracking objects (in the graphical objects sense), such as streamlines, injectors, and massed injectors. Likewise, the tracking module uses one code section to calculate all the different types of tracking objects. This allows the developer to quickly add new features, a feature being a new tracking object or a new way of visualizing the tracking objects. For example, suppose it is desired to add a new feature to the display of several different objects including injectors, massed injectors, streamlines, and particle animation by some new algorithm. In a software visualization system in which different code sections are used to visualize the different object, each of the different code sections must be modified. In the preferred embodiment of the invention, however, only one location in the code base must be changed. What is notable here is that in adding/visualizing sprays, the invention goes beyond visualization of the original CFD dataset. In other words, the sprays, which were not modeled by the CFD module, can be visualized anyway because the same algorithm used to calculate flow field streamlines can be applied to calculate particle trajectories from sprays. Usually what is done is to calculate trajectories only of objects in the original dataset (i.e. the dataset calculated by the CFD module). The invention, on the other hand, calculates trajectories of objects not in the original dataset.

CFD Calculation Advancements

12. Use an Object-Oriented Design to have the Viewer Interpret Different Formats of CFD Data in Native Format.

In the preferred embodiment, all of the modules of the invention are implemented according to an object-oriented design, and such an implementation allows the viewer (set of modules) of the implementation to interpret any of several different types (formats) of CFD data. In implementations based on other than an object-oriented design, the resulting data visualization tool is limited to using only one type of data at a time. With a non-object-oriented design, if the format of the data (for example the grid structure related to the specific CFD program being used) must be changed, the data visualization tool must be recompiled.

To understand the significance of this, it is important to understand a subtlety of the query library. It interprets the CFD data into a “standard format” on the fly. There is no data interpolation of the native dataset into a new structure based on what the visualization code needs. Rather, the query library gets a request for a value at a point (x,y,z,t) location and provides the value using the functions specifically designed to work with a particular CFD module (or other data source module). Such a query library implementation retrieves more accurate data than an implementation that interpolates native CFD data to its own grid. Conventional viewers are sometimes compatible with many different CFD modules (and therefore their different data formats), but use interpolation to be compatible, and so provide less accurate data visualization than is provided by the invention.

13. Use an Object-Oriented Design to Allow Multiple Types of Cells in a Single CFD Output File.

In an object-oriented design, which is the preferred implementation, a single CFD data set can include different cell types (for example, tetrahedral cells vs. hexahedral cells, nested grids, or other cell types) in the same model (i.e. within the same grid). In the preferred embodiment, an object-oriented design is used to provide that each cell is handled as its native type, i.e. each cell is used without converting it to another cell type. In other words, for example, pyramid-shaped cells are not changed into cube-shaped cells. Thus, no interpolation is performed. Because each cell type is handled independently, even within the same file, a more precise value is obtained from a cell (since no interpolation is performed) than would be provided in case of a visualization tool that converts cell types; it is never necessary to translate from one grid format to another grid format to satisfy the needs of a viewer.

It should be understood that being able to handle the grid structures of different CFD codes is distinct from being able to handle the different cell structures within a single grid. Both features are the result of the design of the communications between the query library and the rest of the modules as well as an object-oriented design, particularly within the query library. The communication gives point information, not cell information, forcing the computation algorithms to be cell-independent.

14. Provide for Plugable Readers for CFD Data Sets (or Data Sets from any Other Data Source Program).

In the preferred embodiment, users are able to write a CFD reader for their specific data set. In other words, the visualization software of the invention, in the preferred embodiment, can be used with any type of dataset. All that is necessary is to provide an extension of the query library that provides point information and summary information on the new type of data set in the standardized format used in the visualization software. This allows any type of data to be pulled into the application including data from custom CFD applications. In other words, the visualization tool of the invention is extensible, as is any computer software system, but extensible via plug-ins that are not simply data-converters; the plug-ins of the (preferred embodiment of the) invention are part of the query library and give point information, not cell information, to the other modules of the invention.

15. Provide for Defining Injector Characteristics Via Plug-Ins.

In the preferred embodiment, injector plug-ins in the visualization object client/graphics module are used to enable a user to define any kind of injector, or to change the injector properties (such as jet shape) being visualized. Thus, the invention allows visualizing sprays that are not part of the CFD dataset; the invention calculates the sprays as a design tool inside the visualization program, and the sprays can be modified via plug-ins. (Any injector properties can be changed to a series of particles with initial conditions for position, velocity, direction, and chemical properties. The tracking module then takes these initial conditions and calculates the spray from them. An application of the invention to a particular problem can thereby be extended to allow a user to design a completely new type of injector as a brand new part of the application.)

16. Provide for Defining Particle Sprays Via Plug-Ins.

Likewise, in the preferred embodiment, particle plug-ins are used to enable a user to develop different particle characteristics, e.g., water vs. urea solution vs. other chemical solution. Whereas an injector plug-in tailors an injector itself, a corresponding particle plug-in is used to tailor the spray constituent of the injector.

17. Perform Contour Plane Construction by Regular Grid Sampling.

In the preferred embodiment, contour planes are constructed by sampling points on a regular two-dimensional grid intersecting the CFD solution, as opposed to having the viewer generate a contour based on the CFD grid structure. (The “intersecting” here is intersecting in the mathematical sense. For example, a solid representing the CFD solution is intersected with a plane in which is imposed a grid. Each point on the grid is then sampled.) In other words, in the preferred embodiment, the contours generated by the viewer are grid-independent; the contours that can be generated do not in any way depend on the particular grid used by the CFD module. The way contour planes are constructed by the invention falls out of the software design decisions (beginning with the decision to hide grid information whenever possible).

Geometry Advancements

18. Use a Configuration File to Extend the Number and Types of Textures Used in Geometry Display.

In the preferred embodiment, a user is able to modify a configuration file to add or customize the texture displayed on the geometry. (In the visualization window, the geometry may be displayed as a wireframe or as solid walls, and one speaks of providing a surface texture “on the geometry.” For example, walls may be best represented by tubes along the walls, as for a boiler, or as bricks, or any other texture, depending on the problem.) This allows the user to add any desired texture.

19. Color-Code Geometry Blocks.

The geometry manager can color its blocks using different colors, simplifying the picking of a particular geometry block. (A geometry file is built inside of a desktop viewer starting from a box by cutting the box repeatedly into “geometry blocks” and reshaping the geometry blocks.)

Discussion and an Embodiment Including Two Viewers

Different viewers implemented according to the invention, such as the desktop viewer and VR Viewer, may use a different instance of the interface module, for example, but the remaining modules and code are left unchanged because the basic tasks required are the same. For example, the users of different viewers see a different interface to request the display of a streamline. But the requests can be sent to the exact same visualization object module to get the streamline object, which in turn requests the streamline data from the exact same tracking module. The tracking module gets the data through the same instance of the query library, which interprets the same data source output. The final streamline is then passed back up the modules and displayed. So, while Viewer programs like the desktop Viewer and VR Viewer appear to be different programs, they are implemented using essentially the same modules, and one can be converted into another by replacing typically only one or two modules of one with the corresponding modules used in the other.

Referring now to FIG. 4, the invention allows in particular a distributed data visualization tool, including two or more viewers on different hosts, both simultaneously communicating with a CFD module (13) on one of the host computers. The different viewer modules are essentially the same except for the interface module. One of the viewers, a field-computer viewer 14a, is hosted by a field computer 41, and the other viewer, an office computer viewer 14b, is hosted by an office computer 42. The field-computer viewer 14a would usually be the more limited desktop viewer, and the office-computer viewer 14b would be the VR viewer, providing an immersive view. In such an embodiment, where the programming interfaces of the modules (interfaces between a module and the other modules) are the same so that the fully immersive office-computer (VR) viewer and the more limited field-computer (desktop) viewer use the same model data, a worker at the office location can experience an immersive view of the same data used by a field worker, who is able to experience only the corresponding non-immersive view, thereby enabling remote collaboration. The various component modules of the viewer on the office computer can be compiled and linked together (with or without the CFD module) in all of the ways described above, and the modules of the viewer on the field computer can be compiled and linked together in all of the ways that do not integrate the CFD module.

Another Embodiment of the Viewer Module

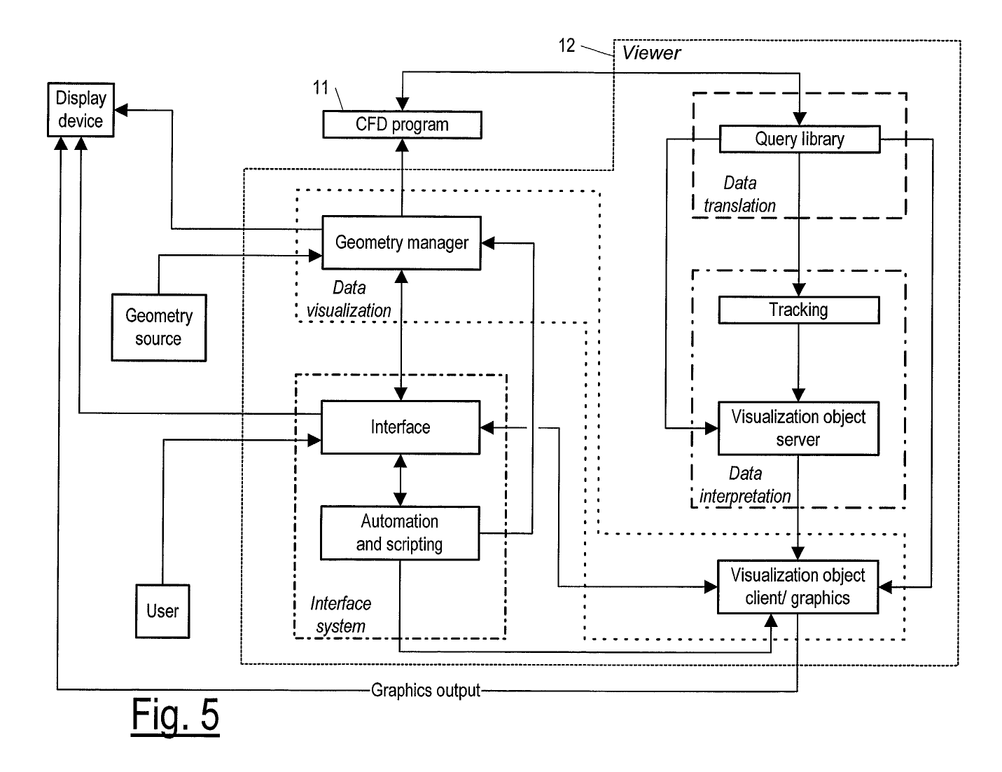

Referring now to FIG. 5 and also to FIG. 2, in another embodiment, the viewer module 12 can be implemented as four modules, what are here called viewer super-component modules (as opposed to the seven viewer component modules of FIG. 2): a data translation module, including the query libraries along with the data file readers; a data interpretation module, including the tracking module and the visualization object server module; a data visualization module, including the visualization object client/graphics module and the geometry manager; and a user interface system module, including the above interface module and the automation and scripting module. Thus, the viewer module 12 of the invention is shown as capable of being represented or implemented according to various levels of abstraction, so that the viewer module 12 is not necessarily a collection of the seven component modules illustrated in FIG. 2 (namely, the geometry module, the interface module, the automation and scripting module, the query library, the tracking module, the visualization object server, and the visualization object clients/graphics server). Instead, the viewer module 12 is defined in terms of the functionality achieved by the seven viewer component modules of FIG. 2. Thus, the invention comprehends embodiments in which the viewer module 12 is implemented as for example the four viewer super-component modules of FIG. 5, with allocations of functionality as indicated by the viewer component modules making up each viewer super-component module.

Scope of the Invention

It is to be understood that the above-described arrangements are only illustrative of the application of the principles of the present invention. In particular, nothing about the invention necessarily restricts the invention to the design of urea injection nozzle systems for boilers, and the invention is intended to comprehend tools for complex data analysis and engineering design in general. Numerous other modifications and alternative arrangements may be devised by those skilled in the art without departing from the spirit and scope of the present invention. In particular, other data sources besides a CFD module for providing combustion process data are intended to be encompassed by the invention. Such other data sources include a CFD program for generating meteorological data, or a program that simply accumulates and provides (with perhaps some minor processing) empirical (not calculated) meteorological data. In context, a program that provides empirical or calculated data on the transport of pollution species is also intended to be within the scope of the invention. Such other data sources also include a CFD module used to calculate blood flow in a heart, or a module that calculates internal stress in an engine clock or in the foundation of a building, or a module that calculates decibel levels in a three-dimensional enclosure depending on the placement of speakers or noise sources, or a module that calculates the electromagnetic field arising from source quantities (currents and charges), such as might be done in designing an electrostatic precipitator. Even other data sources are also intended to be covered by the invention. The appended claims are intended to cover the other data sources and the modifications and different arrangements comprehended by the invention.

What is claimed is:

1. A hardware-adaptable data visualization tool for use in visualizing data from a data source, comprising:
a) a data source module, responsive to data source input files indicating information about a geometry to be visualized, for providing as a stream of data to be interpreted a numerical data set representing aspects of the data; and
b) a viewer module, for providing the data source input files, responsive to the numerical data set for providing a view of the numerical data set helpful to a user in interpreting the numerical data set;
wherein the viewer module in turn comprises a plurality of viewer component modules, and wherein the source module and the viewer component modules are compiled and linked together into one or more executable files depending on factors including at least either the performance capabilities of a predetermined target host or hosts or the desired utility of the executable files, the component modules having programming interfaces that are substantially independent of the predetermined target host or hosts, whereby different visualization tools are able to be provided all from the same data source module and viewer component modules, the different visualization tools being tailored to different performance capabilities of different target hosts.

2. A hardware-adaptable data visualization tool as claimed in claim 1, wherein the viewer component modules comprise:
a) a geometry manager, responsive to geometry information describing the boundaries of a geometry corresponding to a region being viewed and responsive to changes in the geometry information and associated display characteristics, for providing a representation of the boundaries of the region being viewed, and for providing the data source input files including information about the geometry;
b) an interface module, serving as the means by which a user of the data visualization tool requests views or requests to view objects, responsive to user tool controls and inputs, for providing changes to the geometry and associated display characteristics, for providing display characteristics associated with graphic representations of visualization objects, for providing flight plans indicating information for providing a view of the numerical data set, and also responsive to summary data, and further for providing graphics output of the summary data;
c) an automation/scripting module, for maintaining flight plans or other standardized instructions for viewing the numerical data set, responsive to the flight plans, for providing changes to display characteristics associated with the flight plans;
d) a visualization object client/graphics module, for retrieving, storing, and displaying dynamic visualization objects that represent information in the numerical data set, responsive to changes to display characteristics, responsive to and for providing summary numerical data, and responsive to visualization data, and for providing graphics representations of visualization objects;
e) a visualization object server, for generating graphical objects, responsive then to data for generating graphical objects, for providing the generated graphical objects;
f) an auxiliary calculation module set, for translating the numerical data set after standard formatting into data for visualization, for providing the data for visualization; and
g) a query library module, for converting different data source program data structures into a standard application programming interface and so allowing visualization of data from data source programs that output data in different formats, responsive to the numerical data set, for providing the numerical data set according to standard formatting;
wherein the data source module is selected from the group consisting of calculatory data source modules and non- calculatory data source modules.

3. A hardware-adaptable data visualization tool as claimed in claim 2, wherein the data source module is a computational fluid dynamics (CFD) module.

4. A hardware-adaptable data visualization tool as claimed in claim 2, wherein all of the viewer component modules are compiled and linked together into a single executable file and the data source module is compiled into a separate executable file, thereby providing a data visualization tool in which computing equipment most suitable for computation can be used as a host of the data source module, and computing equipment most suitable for providing a view helpful in interpreting the data stream provided by the data source module can be used as a host of the viewer.

5. A hardware-adaptable data visualization tool as claimed in claim 2, wherein the data source module is linked together into a single executable file, the query module, the auxiliary calculational module set, and the visualization object server module are compiled and linked together into a single executable file, and the other component modules of the viewer module are compiled and linked together into a single executable file, thereby a data visualization tool that is distributed across up to three different target hosts, communicating via a network and/or a file system.

6. A hardware-adaptable data visualization tool as claimed in claim 2, wherein the data source module, the auxiliary calculational module set, such as the tracking module, and the query module are compiled and linked together into one executable file, thereby making possible the use of the tracking module to generate information on spray trajectories or other similar information generated by an other auxiliary calculational module and used as a basis for source term inputs to the data source module during execution, and wherein the remaining modules, however compiled and linked, form the viewer.

7. A hardware-adaptable data visualization tool as claimed in claim 2, wherein all of the viewer component modules and the data source module are compiled and linked together into a single executable file, thereby providing a viewer with a capability of examining intermediate results of the data source module as it performs a calculation and steering the calculation of the data source module.

8. A hardware-adaptable data visualization tool as claimed in claim 2, wherein the data source module, the query library module, the auxiliary calculational module set, and the visualization object server are all compiled and linked together into one executable file, and the other modules, the principal viewer modules, are all compiled and linked together into a second executable file, and wherein the viewer is connected to the data source module via a network link, and so is able to examine intermediate results of the data source module as it performs a calculation and steer the calculation as the data source module is performing the calculation.

9. A hardware-adaptable data visualization tool as claimed in claim 1, wherein the tool is used for the analysis and engineering design of a fluid dynamic system, wherein the data for visualization provided by the tracking module is particle trajectory data, and further wherein:
a) the data source module is a computational fluid dynamics (CFD) module, responsive to data on the geometry of the fluid dynamic system, and provides, as a stream of data to be interpreted, a numerical data set representing flow; and
b) the viewer module is responsive to the numerical data set representing flow, and provides the data on the geometry of the fluid dynamic system, and also provides a view of the numerical data set representing flow in an environment, such as a fully immersive environment, that helps a user interpret the numerical data set.

10. A hardware-adaptable data visualization tool as claimed in claim 1, wherein the tool is used for the analysis and engineering design of a fluid dynamic system in which a reacting flow occurs, and further wherein:
a) the data source module is a computational fluid dynamics (CFD) module, responsive to data on the geometry of the fluid dynamic system, and further responsive to data on sources of reacting species being added to the reacting flow, and provides, as a stream of data to be interpreted, a numerical data set representing flow and other characteristics of the reacting flow; and
b) the viewer module is responsive to the numerical data set representing flow and other characteristics of the reacting flow, and provides the data on the geometry of the fluid dynamic system, and also provides a view of the numerical data set representing flow and other characteristics of the reacting flow in an environment, such as a fully immersive environment, that helps a user interpret the numerical data set.

11. A hardware-adaptable data visualization tool as claimed in claim 1, wherein the tool is for use in designing targeted in-furnace injection systems, such as pollution control systems, for controlling a combustion process, the special features for introducing into the combustion process species that react with the combustion products, and further wherein:
a) the data source module is a computational fluid dynamics (CFD) module, responsive to data on the geometry of the combustion system including the special features, and further responsive to data on sources of the reacting species being added to the combustion process, and provides, as a stream of data to be interpreted, a numerical data set representing flow and other characteristics of the combustion process; and
b) the viewer module is responsive to the numerical data set representing flow and other characteristics of the combustion process, and provides the data on the geometry of the combustion system including the special features, and also provides a view of the numerical data set representing flow and other characteristics of the combustion process in an environment, such as a fully immersive environment, that helps a user interpret the numerical data set.

12. A hardware-adaptable data visualization tool as claimed in claim 1, wherein the data visualization tool comprises two or more different viewer modules, wherein one viewer module is hosted by a first computer, another viewer module is hosted by a second computer, and so on, and wherein the viewer modules use the same model data.

13. A hardware-adaptable data visualization tool as claimed in claim 1, wherein multiple synchronized dialog boxes are used to prevent data corruption.

14. A hardware-adaptable data visualization tool as claimed in claim 1, wherein separate control dialog boxes and visualization windows are provided.

15. A hardware-adaptable data visualization tool as claimed in claim 2, wherein a strong scripting language is used to provide input to the automation and scripting module for directing real-time visualization.

16. A hardware-adaptable data visualization tool as claimed in claim 1, wherein a script file is used to generate a complex visualization picture.

17. A hardware-adaptable data visualization tool as claimed in claim 1, wherein object structures are provided that can use the same graphics libraries with more than one VR base library, including a CAVElib based application or a VR Juggler based application.

18. A hardware-adaptable data visualization tool as claimed in claim 1, wherein the viewer places multiple graphical representations of particles on a single streamline, allowing the streamline to visually represent more particles than are calculated.

19. A hardware-adaptable data visualization tool as claimed in claim 1, wherein streamlines are colored by time of life.

20. A hardware-adaptable data visualization tool as claimed in claim 1, wherein a programming interface is provided allowing a user to code a color map using one or another function f(s) for mapping a scalar value s to a desired color.

21. A hardware-adaptable data visualization tool as claimed in claim 1, wherein one code section is used to visualize all different types of graphical tracking objects, such as streamlines, injectors, and massed injectors.

22. A hardware-adaptable data visualization tool as claimed in claim 2, wherein each of the modules are implemented according to an object-oriented design so as to allow the viewer to interpret any type of data.

23. A hardware-adaptable data visualization tool as claimed in claim 1, wherein each of the modules are implemented according to an object-oriented design so as to allow the application to interpret different types of cells in a single data source output file.

24. A hardware-adaptable data visualization tool as claimed in claim 1, wherein each of the modules are implemented according to an object-oriented design so as to allow plugable readers for data sets provided by the data source program.

25. A hardware-adaptable data visualization tool as claimed in claim 1, wherein injector characteristics are definable via a plug-in.

26. A hardware-adaptable data visualization tool as claimed in claim 1, wherein particle plug-ins are used to enable a user to develop different particle characteristics.

27. A hardware-adaptable data visualization tool as claimed in claim 1, wherein contour planes are constructed by sampling points on a regular two-dimensional grid, thereby providing contours that are grid-independent.

28. A hardware-adaptable data visualization tool as claimed in claim 1, wherein the viewer component modules comprise:
a) a data visualization module, responsive to geometry information describing the boundaries of a geometry corresponding to a region being viewed and responsive to changes in the geometry information and associated display characteristics, for providing a representation of the boundaries of the region being viewed, and for providing the data source input files including information about the geometry, and also for retrieving, storing, and displaying dynamic visualization objects that represent information in the numerical data set and so responsive to changes to display characteristics, also responsive to and for providing summary numerical data, and responsive to visualization data, and for providing graphics representations of visualization objects;
b) an interface system module, an interface module, serving as the means by which a user of the data visualization tool requests views or requests to view objects, responsive to user tool controls and inputs, for providing changes to the geometry and associated display characteristics, for providing display characteristics associated with graphic representations of visualization objects, and also responsive to summary data, and further for providing graphics output of the summary data, also for maintaining flight plans or other standardized instructions for viewing the numerical data set, for providing changes to display characteristics associated with the flight plans;
c) a data interpretation module, for generating graphical objects, responsive to data for generating graphical objects, for providing the generated graphical objects, and also for translating the numerical data set after standard formatting into data for visualization, for providing the data for visualization; and
d) a data translation module, for converting different data source program data structures into a standard application programming interface and so allowing visualization of data from data source programs that output data in different formats, responsive to the numerical data set, for providing the numerical data set according to standard formatting;
wherein the data source module is selected from the group consisting of calculatory data source modules and non-calculatory data source modules.
